(19) United States
(12) Patent Application Publication
(10) Pub. No.: US 2026/0291704 A1
(43) Pub. Date: Sep. 24, 2026

(54) METHODS TO ADDRESS ISSUES ARISING OUT OF SUBBAND FULL DUPLEXING IN A CELLULAR COMMUNICATION NETWORK

(71) Applicants: CENTRE OF EXCELLENCE IN WIRELESS TECHNOLOGY, Chennai Tamil Nadu (IN); INDIAN INSTITUTE OF TECHNOLOGY MADRAS (IT MADRAS), Chennai, Tamil Nadu (IN)

(72) Inventors: Priyanka DEY, Chennai Tamil Nadu (IN); Deepak Padmanabhan MAYAKUMARI, Chennai Tamil Nadu (IN); Vishakha SINGH, Chennai Tamil Nadu (IN); Jeniston Deviraj Klutto MILLETH, Chennai Tamil Nadu (IN); Bhaskar RAMAMURTHI, Chennai Tamil Nadu (IN)

(73) Assignee: INDIAN INSTITUTE OF TECHNOLOGY MADRAS (IIT MADRAS), Chennai, Tamil Nadu (IN)

(21) Appl. No.: 19/471,713

(22) PCT Filed: Apr. 12, 2024
(86) PCT No.: PCT/IN2024/050390

§ 371 Date: Oct. 2, 2025

(30) Foreign Application Priority Data
Apr. 14, 2023 (IN) 202341027624

(51) Int. Cl. H04L 5/14; H04B 7/06; H04L 5/00; H04W 72/231; H04W 76/20

(52) U.S. Cl. CPC H04L 5/14; H04B 7/06968; H04L 5/0051; H04W 72/231; H04W 76/20

(57) ABSTRACT

A method of implementing SBFD comprises receiving an RS configuration and an SBFD configuration comprising at least one RS resource. It is identified that the at least one RS resource spans over at least one first resource and at least one second resource. The at least one first resource is an SBFD resource and the at least one second resource is a non-SBFD resource. One of discarding the RS configuration, discarding the at least one RS resource, and one of transmitting and receiving the at least one RS considering the at least one first resource and the at least one second resource to be one of SBFD resource and a non-SBFD resource based on at least one rule is performed. Further, one of transmitting and receiving the at least one RS in one of at least one first resource and at least one second resource is performed.

### FIELD OF THE INVENTION

The present invention relates to subband full duplexing in a cellular communication network, and more particularly to addressing issues arising in subband full duplexing.

### BACKGROUND OF THE INVENTION

In sub band full duplexing (SBFD) communication, a node can simultaneously perform downlink (DL) and uplink (UL) operations in different subbands within a same carrier frequency. The frequency resource within the same carrier frequency can be of fully overlapping, partially overlapping, or non-overlapping subbands. FIG. 1 cumulatively illustrates different types of SBFD subbands. FIG. 1a illustrates carrier configured for SBFD operation with non-overlapping subbands, FIG. 1b illustrates carrier configured for SBFD operation with partially overlapping subbands, and FIG. 1c illustrates carrier configured for SBFD operation with fully overlapping subbands.

One major drawback of SBFD operation is self-interference (SI) caused by simultaneous DL and UL transmission and reception, respectively in a node. In case of SBFD with non-overlapping subbands, guard bands can be used between the frequency resources for DL and UL operation to minimize the impact of SI.

In fifth generation new radio (5G-NR) specification, a carrier can be configured for either DL or UL operations at a time. In SBFD, subbands can be configured within the carrier and subbands can be simultaneously configured for different set of operations (E.g., DL and UL). Below explained scenarios may arise within a carrier due to frequency domain configuration for SBFD.

In one scenario i.e. DUD scenario, UL subband may exist within same carrier configured for DL for a time resource. In this scenario, the UL subband is sandwiched between two DL subbands. For example, carrier is configured for DL operation in a time resource using the techniques defined in 5G-NR. Simultaneous UL operation can be enabled within the same carrier by configuring a UL subband, for UL operation, and activating it in the time resource. In another example, the base station (gNB) can configure a UL subband within the same carrier, configured for DL operation using methods defined in 5G-NR, and can schedule UL transmission from user equipment (UE) in the configured UL subband. Therefore, the gNB will simultaneously perform DL transmission to a UE in the DL subband and UL reception from another UE in the UL subband within the same carrier.

In another scenario i.e. UDU scenario, the DL subband may exist within the same carrier configured for UL for a time resource. In this scenario, the DL subband is sandwiched between two UL subbands. For example, the carrier is configured for UL operation in a time resource using one of the methods defined in 5G-NR specification. Now, the simultaneous DL operation can be enabled within the same carrier by configuring a DL subband, for DL operation, and activating it in the time resource. In another example, the gNB can configure a DL subband within the same carrier, configured for UL operation using one of the methods defined in 5G-NR specification, and can schedule DL transmission to a UE in the configured DL subband. Therefore, the gNB can simultaneously perform UL reception in the UL subband and DL transmission to another UE in DL subband.

Further, the SBFD operation can be enabled for a set of time resources, referred as SBFD active time resources in this document, in which the subband is active. The SBFD active time resource can be contiguous or discontiguous. The time resource granularity can be at symbol level, at slot level or resource type within a slot. FIG. 2 illustrates a notion of UL subband and SBFD active time resources, in accordance with an embodiment of the present invention. A resource grid consisting of 8 resource blocks (RBs) and 7 symbols within a carrier is shown. The carrier is configured to perform DL operation using conventional methods. In SBFD, the portion from RB1 to RB4 can be configured as UL subband and UL operation can be configured within the subband. It can be seen that the UL subband is active only from symbols 1 to symbol 5 and is denoted as SBFD active time resources.

Further, in FIG. 2, symbols 1-5 are SBFD symbols while symbols 0, 6, 7 are non-SBFD symbols. Certain characteristics of SBFD and non-SBFD symbols are quite different from each other. For example, the interference profile of an SBFD symbol is different from that of a non-SBFD symbol due to the simultaneous transmission in both UL and DL subbands. Similarly, the interference profile varies within an SBFD symbol for non-overlapping/partially overlapping subbands due to the leakage from adjacent subband. Further, in terms of resources, a full UL non-SBFD symbol has more UL frequency resources than an UL subband in an SBFD symbol. This will have an impact on the scheduling of UL resources for SBFD and non-SBFD symbols.

An SBFD symbol consists of both DL and UL subbands whereas a non-SBFD symbol consists only DL or ULin all the frequency resources of the symbol. The gNB transmits CSI-RS in DL, which is received by the UE to perform channel/interference measurements. The interference profile measured by the UE using the CSI-RS transmitted in a DL non-SBFD symbol might be different from the one measured on a non-SBFD symbol. The major reason for this is that all the UEs in the network are receiving in DL in a non-SBFD DL symbol, whereas, in an SBFD symbol, some UEs in the network are receiving in DL while some are performing UL. The UL signals transmitted by the UEs will cause interference to the DL received CSI-RS by other UEs. This is referred to as inter-subband interference. This inter-subband interference will be more towards the edge of the DL resources that are adjacent to the UL subband as compared to the DL resources that are farther away from the UL subband. Similarly, when the gNB receives SRS in UL, the interference conditions will be different in SBFD and non-SBFD symbols due to self-interference at the gNB as well as inter-subband interference existing only in the SBFD symbols.

Therefore, there arises a need of methods for addressing the above mentioned limitations arising in subband full duplexing.

### OBJECTS OF THE INVENTION

A general objective of the present invention is to address issues arising out of subband full duplexing in a cellular communication network.

Another objective of the invention is to addresses various impacts of having SBFD time-frequency resources in a network.

### SUMMARY OF THE INVENTION

The summary is provided to introduce aspects related to methods of addressing issues arising out of subband full duplexing in a cellular communication network, and the aspects are further described below in the detailed description. This summary is not intended to identify essential features of the claimed subject matter nor is it intended for use in determining or limiting the scope of the claimed subject matter.

In one embodiment, a method of implementing Sub Band Full Duplexing (SBFD) in a cellular network comprises receiving, by an at least one first node, a reference signal (RS) configuration and an SBFD configuration, wherein the RS configuration comprises at least one RS resource. The method further comprises identifying, by the at least one first node, that the at least one RS resource spans over at least one first resource and at least one second resource. The at least one first resource is an SBFD resource and the at least one second resource is a non-SBFD resource. The method further comprises performing, by the at least one first node, one of discarding the RS configuration, discarding the at least one RS resource, one of transmitting and receiving the at least one RS considering the at least one first resource and the at least one second resource to be one of SBFD resource and a non-SBFD resource based on at least one rule, and one of transmitting and receiving the at least one RS in one of at least one first resource and at least one second resource.

In one aspect, the at least one RS resource is indicated using at least one RS identity (ID).

In one aspect, the rule is one of predefined in the specification and indicated by at least one second node.

In one aspect, the rule is indicated using at least one of radio resource control (RRC) or medium access control-control element (MAC-CE) or downlink control information (DCI).

In one aspect, the at least one first resource and the at least one second resource are consecutive in time domain.

In one aspect, the at least one RS resource spans over the at least one first resource and the at least one second resource when one of the at least one RS is repeated, and the at least one RS is periodic.

In one aspect, receiving the at least one RS further comprises:
measuring, by the at least one first node, at least one parameter using the at least one RS; and
reporting, by the at least one first node, the at least one parameter.

In one aspect, measuring the at least one parameter is one of
based on the recently received at least one RS, and
based on the average of the measurements obtained using the at least one RS.

In one aspect, the method further comprises receiving by the at least one first node, a Quasi Co-location (QCL) information, wherein the QCL information comprises at least one of a control channel and a data channel QCLed with the at least one RS. The method further comprises performing, by the at least one first node, one of discarding the QCL information, applying QCL information of the at least one RS in the at least one first resource for at least one of receiving and decoding at least one of the control channel and the data channel, and applying QCL information of the at least one RS in the at least one second resource for at least one of receiving and decoding at least one of the control channel and the data channel.

In one aspect, applying QCL information of the at least one RS in the at least one first resource is performed when at least one of the control channel and the data channel is scheduled in an SBFD resource.

The method further comprises pplying QCL information of the at least one RS in the at least one second resource is performed is when at least one of the control channel and the data channel is scheduled in a non-SBFD resource.

In one embodiment, a method of implementing a Sub Band Full Duplexing (SBFD) in a cellular network comprises receiving, by at least one first node, at least one reference signal (RS) configuration and a SBFD configuration, wherein the at least one RS configuration comprises at least one of at least one first RS resource and at least one second RS resource. The method further comprises identifying, by at least one first node, one of the at least one first RS resource is in an SBFD resource and at least one second resource is a non-SBFD resource, and the at least one first RS resource is a non-SBFD resource and at least one second resource is a SBFD resource. The method further comprises performing, by the at least one first node, one of discarding the RS configuration, discarding the at least one first RS and at least one second RS, and one of transmitting and receiving the at least one first RS and the at least one second RS on the resources overlapping in frequency domain of the at least one first RS and at least one second RS based on a rule.

In one aspect, at least one first RS resource is for channel measurement and at least one second RS resource is for interference measurement.

In one aspect, the rule is one of predefined in the specification and signaled by at least one second node.

In one aspect, the rule is signaled using at least one of radio resource control (RRC) message, medium access control-control element (MAC-CE) and downlink control information (DCI).

In one aspect, the resources overlapping in frequency domain are one of the resources where one of transmission and reception is permissible andthe resources configured in at least one RS configuration.

In one aspect, the method further comprises determining, by the at least one first node, at least one parameter using the at least one first RS and at least one second RS.

In one aspect, the at least one parameter is identified from the RS configuration.

In one embodiment, A method of implementing a Sub Band Full Duplexing (SBFD) in a cellular network comprises receiving, by at least one first node, a reference signal (RS) configuration and a SBFD configuration, wherein the RS configuration comprises a plurality of RS resources. The method further comprises identifying, by the at least one first node, at least one first RS resource from the plurality of RS resources in a SBFD resource and at least one second RS resource from the plurality of RS resources in a non-SBFD resource; and sending, by the at least one first node, a report based on at least one of the at least one first RS resource and the at least one second RS resource.

In one aspect, receiving by the at least one first node further comprises receiving an indication, wherein the indication comprises report for at least one of SBFD resource and non-SBFD resource.

In one aspect, the method further comprises indicating, by the at least one first node, the report is for at least one of the SBFD resource and the non-SBFD resource.

In one aspect, receiving, by the at least one first node, further comprises receiving at least one of at least one first RS in SBFD resource and at least one second RS in non-SBFD resource. The method further comprises measuring, by the at least one first node, at least one of at least one first parameter using the at least one first RS and at least one second parameter using the at least one second RS.

In one aspect, the RS configuration comprises at least one parameter to report based on the plurality of resources.

In one embodiment, a method of implementing a Sub Band Full Duplexing (SBFD) in a cellular network comprises receiving, by at least one first node, configuration for at least one channel and a configuration for SBFD. The method further comprises identifying, by the at least one first node, the at least one channel spans over at least one first resource and at least one second resource; wherein the at least one first resource is a SBFD resource and the at least one second resource is a non-SBFD resource. The method further comprises performing, by the at least one first node, one of discarding the at least one channel, one of transmission and reception of the at least one channel using at least one first parameter in the at least one first resource and at least one second parameter in the at least one second resource, and one of transmission and reception of the at least one channel using at least one third parameter in the at least one first resource and in the at least one second resource.

In one aspect, the at least one channel is one of a data channel and a control channel.

In one aspect, discarding is when at least one of frequency hopping is enabled and resources for transmission of UL data falls outside the resource configured for UL by the configuration for SBFD.

In one aspect, one of at least one first parameter and at least one third parameter is at least one of FH parameter, TCI state, TDRA, and FDRA.

In one aspect, one of at least one first parameter and at least one third parameter is given by the configuration for at least one channel.

In one aspect, one of at least one first parameter and at least one third parameter is obtained by disabling the FH given by the configuration for at least one channel.

In one aspect, the at least one first parameter is derived from the at least one second parameter based on a rule.

In one aspect, the rule is predefined in the specification and received using one of Radio Resource Control (RRC), Medium Access Control-Control Element (MAC-CE), and Downlink Control Information (DCI).

In one aspect, the at least one second parameter is given by the configuration for the at least one channel.

In one aspect, the configuration for at least one channel is received using one of Radio Resource Control (RRC), Medium Access Control-Control Element (MAC-CE), and Downlink Control Information (DCI).

In one aspect, repetition is enabled for at least one channel or at least one channel is periodic.

In one aspect, discarding at least one channel is in one of the at least one first resource and the at least one second resource based on a rule.

In one aspect, the rule is one of predefined in the specification and indicated to the at least one first node.

In one aspect, the indication is using one of Radio Resource Control (RRC), Medium Access Control-Control Element (MAC-CE), and Downlink Control Information (DCI) signaling.

In one aspect, the third parameter is one of configuration of the at least one channel, configuration of at least one channel overlapping with SBFD resource, and configuration of at least one data channel overlapping with non-SBFD resource.

In one aspect, when the at least one data channel is TBoMS, discarding comprises determining at least one slot for one of transmission and reception of the at least one data channel based on one of a default configuration and indication, wherein the at least one slot is in one of the at least one first resource and the at least one second resource.

In one aspect, discarding is when determining one of the at least one data channel in the at least one first resource and the associated DMRS in the at least one second resource and the at least one data channel in the at least one second resource and the associated DMRS in the at least one first resource.

In one aspect, the at least one third parameter is one of corresponding to the at least one first resource when DMRS associated with the at least one data channel is in the at least one first resource and corresponding to the at least one second resource when DMRS associated with the at least one data channel is in the at least one second resource.

In one embodiment, a method of implementing a Sub Band Full Duplexing (SBFD) operation in a cellular network comprises receiving, by at least one first node, configuration for at least one control channel and a configuration for SBFD. The method further comprises identifying, by the at least one first node, the at least one control channel spans over at least one first resource and at least one second resource. The at least one first resource is a SBFD resource and the at least one second resource is a non-SBFD resource. The method further comprises determining, by the at least one first node, a FH pattern and performing one of transmission and reception based on the FH pattern.

In one aspect, determining further comprises one of discarding the at least one control channel when the starting frequency resource of the FH pattern is outside the resources configured for UL by the configuration for SBFD, transmitting only in the first hop and discarding the second hop, and calculating the RB ID for the second hop such that the resources for at least one control channel are restricted within the resources configured for UL by the configuration for SBFD.

In one aspect, transmitting only in the first hop and discarding the second hop is when one of the RB ID for the second hop falls outside the resources configured for UL, and at least one resource for the second hop falls outside the resources configured for UL.

In one aspect, the calculating is based on one of a predefined rule in the specification and indication received by using at least one of RRC or MAC-CE or DCI.

In one embodiment, a method of implementing a Sub Band Full Duplexing (SBFD) operation in a cellular network comprises receiving, by at least one first node, a configuration for at least one feedback and a configuration for SBFD, wherein the feedback corresponds to a plurality of resources. The method further comprises dividing, by the at least one first node, the plurality of resources into a plurality of subbands. The method further comprises performing one of receiving the at least one feedback on each subband and measuring at least one parameter on each subband and reporting the at least one parameter as feedback.

In one aspect, dividing is based on the configuration for SBFD.

In one aspect, the at least one parameter is at least one of CSI and CLI.

### BRIEF DESCRIPTION OF THE DRAWINGS

FIG. 1a illustrates carrier configured for SBFD operation with non-overlapping subbands.

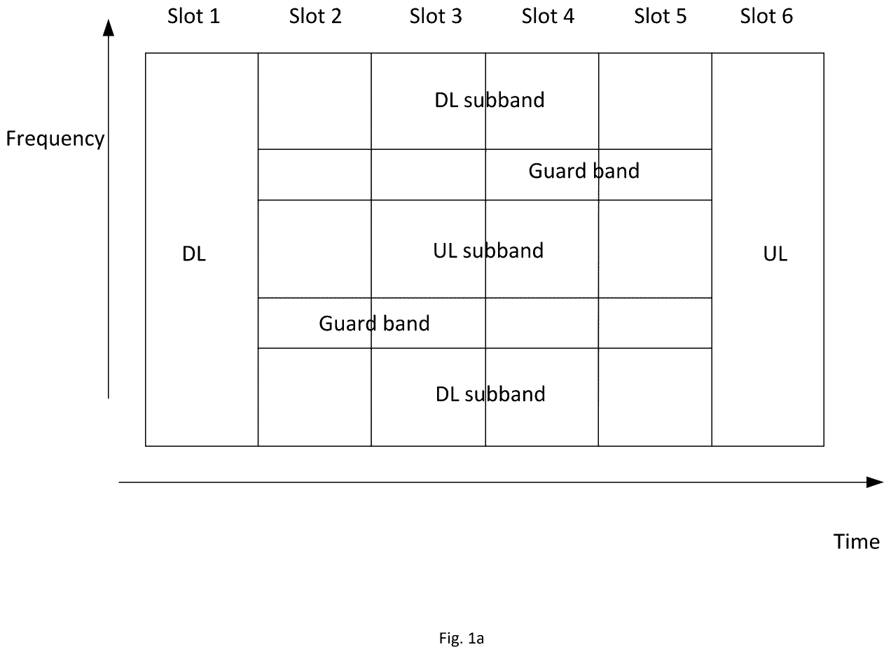

FIG. 1b illustrates carrier configured for SBFD operation with partially overlapping subbands.

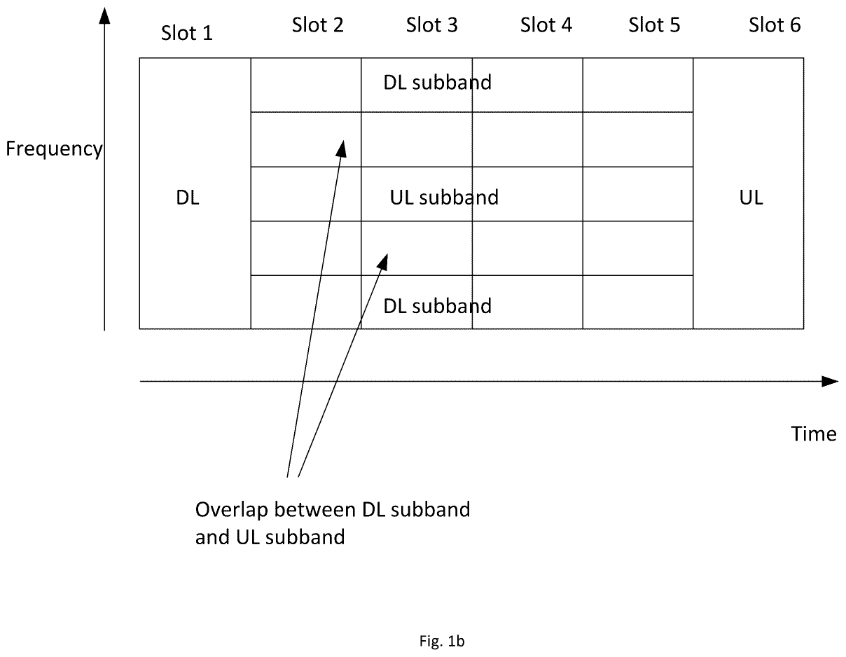

FIG. 1c illustrates carrier configured for SBFD operation with fully overlapping subbands.

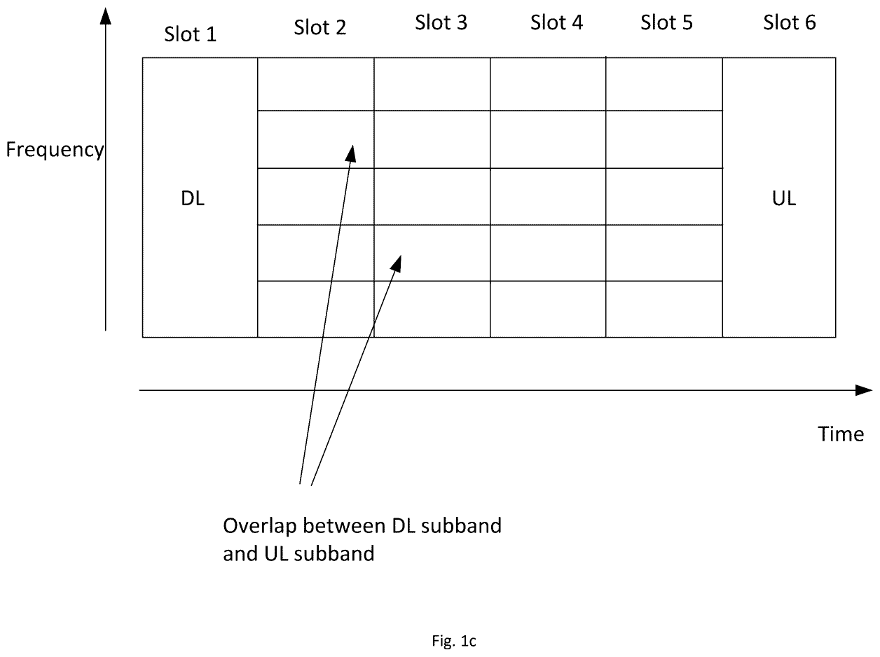

FIG. 2 illustrates a notion of UL subband and SBFD active time resource.

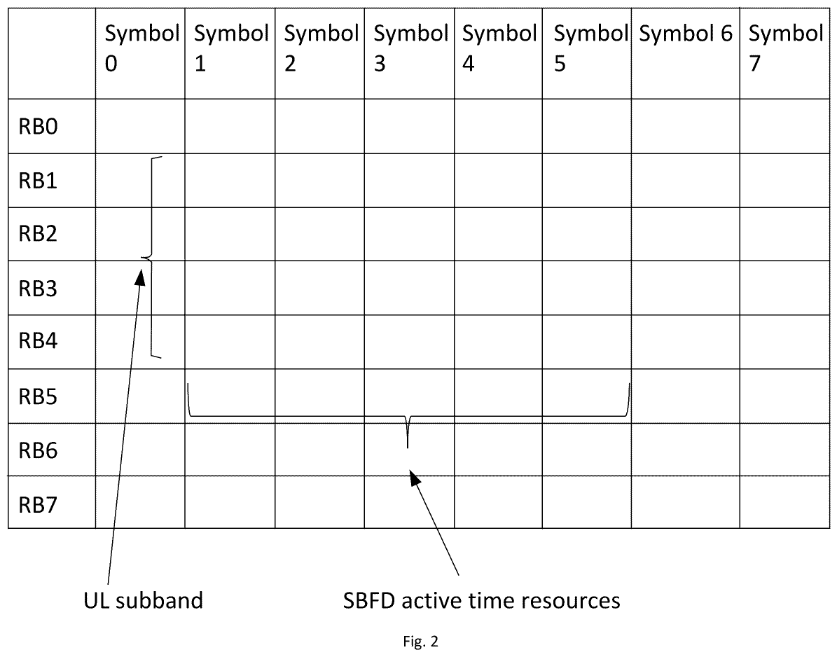

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

CSI-RS/SRS in existing NR specifications or in general, the DL/UL RS for channel/interference measurements are configured by a gNB to UEs. The following are the solutions with respect to different scenarios described in the background section.

In one scenario, same DL/UL RS resource may span over more than one symbol. E.g., in case of repetition of DL/UL RS, when DL/UL RS is periodic, etc. In such scenario, the UE is not expected to receive a configuration where the same DL/UL RS resource spans over both SBFD and non-SBFD symbols. Alternatively, if the UE receives a configuration where the same DL/UL RS resource spans over both SBFD and non-SBFD symbols, the UE discards it. Alternatively, if the UE receives a configuration where the same DL/UL RS resource spans over both SBFD and non-SBFD symbols, it performs transmission or reception of the DL/UL RS based on some rules like that the UE considers all the symbols on which the RS spans as SBFD symbols or the UE considers all the symbols to be non-SBFD symbols by default. These rules can be known to the UE and gNB by defining it in the specification or explicitly indicated to the UE using radio resource control (RRC) or medium access control-control element (MAC-CE) or downlink control information (DCI) signaling by the gNB. The gNB decides on the type for signaling in a proprietary manner.

In another scenario, the UE can be configured with resources for channel and interference measurement and can be configured to measure and report a parameter based on both resources for channel and interference measurement. In certain cases, the resources for channel measurement are on SBFD symbols and resources for interference measurement are on non-SBFD symbols or vice versa. In such scenario, for a particular UL report configuration, the UE does not expect the resources for channel measurement and interference measurement to be in both SBFD and non-SBFD symbols. For example, in NR, each report config consists of resource settings for channel measurement and interference measurement on NZP CSI-RS resources and CSI-IM resources. Each resource setting has multiple resource sets within it and each resource set has multiple resources within it. The report configuration also defines some parameter to be reported like L1-SINR. To measure this SINR, the UE use the resources for channel measurement and interference measurement defined in the report configuration. If the resources for channel measurement and interference measurement are across both SBFD and non-SBFD symbols, the interference profile will change resulting in incorrect report. Hence, the resources for channel measurement and interference measurement should be in either only SBFD symbols or only non-SBFD symbols.

Alternatively, the UE may consider all the symbols used for channel and interference measurement to be of the same type based on some defined rules. For example, if the RS for channel measurement is received on SBFD symbols, then the UE considers that the RS for interference measurement is received also on SBFD symbols. These rules can be pre-defined in the specification or explicitly indicated to the UE by the gNB using RRC or MAC-CE- or DCI signaling. Alternatively, the gNB explicitly indicates the symbol types for channel measurement and/or interference measurement.

In another scenario, repetition of DL/UL RS may occur. In such scenario, the UE is not expected to receive a configuration where the UL/DL RS resource is repeated and spans over both SBFD and non-SBFD symbols. E.g., in NR, a higher layer parameter called “repetition” can be configured to be ON for DL CSI-RS to interpret that the same CSI-RS resource is transmitted multiple times and the parameter to report has to me measured jointly using repeated version of the CSI-RS. To maintain the same interference profile across repeated versions of the CSI-RS, the CSI-RS should be transmitted on only SBFD symbols or only non-SBFD symbols. Alternatively, if the UE receives a configuration where the UL/DL RS resource is repeated and spans over both SBFD and non-SBFD symbols, the UE discards it. Alternatively, if the UE receives a configuration where the UL/DL RS resource is repeated and spans over both SBFD and non-SBFD symbols, it considers that all the symbols over which the repetition happens are of the same type based on some rules. For example, if the first symbol of the repetition/first occasion is an SBFD symbol, the UE considers all the symbols used for repetition as SBFD symbols. Another example can be, that the UE considers all the symbols to be non-SBFD symbols by default. These rules can be predefined in the specification or explicitly indicated to the UE by the gNB using RRC or MAC-CE- or DCI signaling. Similar is the case when the DL/UL RS is periodic and periodic resource falls in SBFD and non-SBFD symbols.

In one scenario, DL/UL RS is repeated or periodic and spans over both SBFD and non-SBFD symbols at different occasions. In such cases, the UE reports based on the measurements on only the most recent UL/DL resource instead of considering all the resources for repetition of periodic transmission or reception. For example, in NR, if the higher layer parameter for time restriction (for channel/interference measurement) in ON, then the UE reports based on the measurements on only the most current UL/DL resource. Hence, this parameter can be set to ON by the gNB. Otherwise, even if this parameter is not ON, the UE reports based on the measurements on only the most current UL/DL resource by default.

In one scenario, Quasi co-location (QCL) may exist among RS, data and control. In NR, the QCL information among RS, data and control is indicated via transmission control indicator (TCI) states by the gNB. For example, if a PDSCH is QCLed with a certain CSI-RS resource ID, then it means that the same antenna ports have been used for transmission of the PDSCH and the CSI-RS by the gNB. Thus, the UL/DL resources with one resource ID should not span across both SBFD and non-SBFD symbols at different occasions. The UE is not expected to receive such a configuration and discards it if it receives.

In another method, the UE QCLs the data/control only with the symbols of the other channel (RS/control/data) which are of the same type as that of the symbols on which the data/control is received. E.g., if the PDSCH is QCLed with a RS ID, which is received on SBFD symbols, then the UE uses the QCL information or consider QCL information as valid only if the PDSCH is received on SBFD symbols.

In one scenario, Channel state information (CSI) report may need to be obtained for SBFD and non-SBFD symbols. In one method, the UE is not expected to receive CSI-RS resources within a resource set on both SBFD and non-SBFD symbols. In another method, if the UE receives CSI-RS resources within a resource set on both SBFD and non-SBFD symbols, it sends separate CSI reports for resources on SBFD symbols and for resources on non-SBFD symbols. In another method, if the UE receives CSI-RS resources within a resource set on both SBFD and non-SBFD symbols, then the UE sends CSI reports for either resources on SBFD symbols or for resources on non-SBFD symbols based on some defined rules in the specification or as indicated by the gNB. It can also indicate to the gNB about the report whether it is linked to resources on SBFD symbols or resources on non-SBFD symbols.

In one scenario, scheduled PDSCH/PUSCH may exist across SBFD and non-SBFD symbols. In one situation, a single occasion PDSCH/PUSCH may exist within a slot. In such case, the scheduled single occasion PDSCH/PUSCH spans across SBFD and non-SBFD symbols within a slot. This will result in an uneven interference profile across the same PDSCH/PUSCH. In one method, the UE is not expected to receive such a configuration. In another method, the UE drops the PDSCH/PUSCH. In NR, frequency hopping (FH) of PUSCH can be enabled within a slot known as intra-slot FH. A non-SBFD UL slot will have more UL frequency resources as compared to an SBFD slot with an UL subband. Therefore, the frequency resources available in SBFD slots might not be enough for FH of the PUSCH. In one method, the UE disables FH in SBFD slots even if it is configured. In another method, the gNB provides different FH configuration for SBFD and non-SBFD slots using RRC or MAC-CE or DCI signaling. In another method, the gNB provides FH configuration for one type of slot and the UE derives the FH configuration for the other based on some rule. The rule can be defined in the specification and/or indicated by the gNB using RRC or MAC-CE or DCI signaling. In another method, if the FH configuration results in transmitting the PUSCH outside UL subband, the UE drops the PUSCH.

In another situation, repetition of PDSCH/PUSCH may occur across slots. In such case, the data is repeated across different slots. E.g., in PUSCH repetition type A in NR, the PUSCH is repeated in the same frequency resources in different slots. In one method, the UE is not expected to receive a configuration where some of the slots in which the repetition occurs are SBFD and some are non-SBFD. In another method, the UE discards repetition in certain slots if some of the slots in which the repetition occurs are SBFD and some are non-SBFD. This can be done based on some rules. In one method, the UE repeats only in one slot type (e.g., only SBFD slots) by default or as indicated by gNB using RRC or MAC-CE or DCI signaling. In NR, FH is allowed across different slots. The gNB provides the starting RB for the first hop and some offset. The RB for the second hop is calculated based on the starting RB, offset and size of UL bandwidth part (BWP). If the BWPs of the SBFD and non-SBFD slots are different, then the UE needs to use the corresponding BWPs for calculating the RB for second hop. In one method, the UE disables FH in SBFD slots even if it is configured.

In another situation, single DCI may be used for scheduling multi PDSCH/PUSCH across SBFD and non-SBFD symbol(s)/slot(s). In such situation, when single DCI schedules multiple PDSCH(s)/PUSCH(s) and multiple PDSCH(s)/PUSCH(s) spread across SBFD and non SBFD symbol(s)/slot(s). In one method, the UE is not expected to receive a configuration where, single DCI schedules multiple PDSCH(s)/PUSCH(s) spread across SBFD and non SBFD symbol(s)/slot(s). In another method, it drops the PDSCH(s)/PUSCH(s) which are falling in SBFD symbols/slots and receives only PDSCH(s)/PUSCH(s)which are falling in non SBFD symbol(s)/slot(s). In another method, it drops the PDSCH(s)/PUSCH(s) which are falling in non-SBFD symbols/slots and receives only PDSCH(s)/PUSCH(s)which are falling in SBFD symbol(s)/slot(s). In another method, there can be some predefined priority rules that can be configured to UE to receive the PDSCH(s)/PUSCH(s) scheduled by single DCI.

Rules may be defined as listed below:
a) When any non-SBFD PDSCH(s)/PUSCH(s) falls in SBFD symbol/slot then based on the priority UE can convert the SBFD symbol/slot to non-SBFD symbol/slot. Then, UE receives PDSCH(s)/PUSCH(s) in one type of symbol/slot.
b) When any SBFD PDSCH(s)/PUSCH(s) falls in non-SBFD symbol/slot then based on the priority UE can convert the non-SBFD symbol/slot to SBFD symbol/slot. Then, UE receives PDSCH(s)/PUSCH(s) in one type of symbol/slot.

In another situation, different FDRA, TDRA and TCI state(s) may be present for multiple PDSCH(s)/PUSCH(s) across SBFD and non SBFD symbols/slot. When single DCI schedules multiple PDSCH(s)/PUSCH(s) and multiple PDSCH(s)/PUSCH(s) spread across SBFD and non SBFD symbol(s)/slot(s). There may be a possibility that there can be unaligned boundaries between resource block group(s)/reporting subband(s) and SBFD subbands for one or more PDSCH(s)/PUSCH(s). Therefore, there should be different FDRA for each PDSCH/PUSCH in single DCI scheduling multiple PDSCH(s)/PUSCH(s). In one method, separate FDRA can be indicated to UE explicitly in DCI for each SBFD and non-SBFD PDSCH(s)/PUSCH(s) type. In another method, there will be only one FDRA can be indicated in DCI for first SBFD/non SBFD PDSCH/PUSCH and using one FDRA, UE can derive the FDRAs implicitly for the other scheduled SBFD/non-SBFD PDSCH(s)/PUSCH(s) type.

In another method, there can be two types of FDRAs indicated in DCI, one common FDRA for the PDSCH(s)/PUSCH(s) which belongs to SBFD symbol/slot and one common FDRA for the PDSCH(s)/PUSCH(s) which belongs to non-SBFD symbol/slot. When single DCI schedules multiple PDSCH(s)/PUSCH(s) and multiple PDSCH(s)/PUSCH(s) spread across SBFD and non SBFD symbol(s)/slot(s). TDRA will be different for SBFD and non-SBFD type of symbol(s)/slot(s) due to uplink sub-band in downlink sub-band or downlink sub-band in uplink sub-band in SBFD symbol/slot type.

In one method, separate TDRA can be indicated to UE explicitly in DCI for each SBFD and non-SBFD PDSCH(s)/PUSCH(s) type. In another method, there will be only one TDRA can be indicated in DCI for first SBFD/non SBFD PDSCH/PUSCH and using one TDRA, UE can derive the TDRAs implicitly for the other scheduled SBFD/non-SBFD PDSCH(s)/PUSCH(s) type.

In another method, there can be two types of different type of TDRA table configured through RRC, one is for PDSCH(s)/PUSCH(s) belongs to SBFD symbol/slot type and another one is for PDSCH(s)/PUSCH(s) belongs to SBFD symbol/slot type. In DCI, there will be two TDRA indicated to UE. UE can apply one common TDRA to the PDSCH(s)/PUSCH(s) which belongs to SBFD symbol/slot and one common TRDA to the PDSCH(s)/PUSCH(s) which belongs to non-SBFD symbol/slot. When single DCI schedules multiple PDSCH(s)/PUSCH(s) and multiple PDSCH(s)/PUSCH(s) spread across SBFD and non SBFD symbol(s)/slot(s). There will be different QCL properties experienced by PDSCH(s)/PUSCH(s) in SBFD and non-SBFD symbol/slot due to uneven interference profile across the SBFD and non-SBFD symbol/slot. Furthermore, there will be different antenna configuration and spatial domain characteristics across multiple PDSCH(s)/PUSCH(s).

In one method, separate TCI state can be indicated in DCI for each SBFD and non-SBFD PDSCH(s)/PUSCH(s) type. In another method, there can be two TCI states indicated in DCI. In this method, UE can apply the one same TCI state to all the PDSCH(s)/PUSCH(s) which belongs to SBFD symbol/slot type and another TCI state to all the PDSCH(s)/PUSCH(s) which belongs to non-SBFD symbol/slot type.

In another situation, single DCI may be used for scheduling TBoMS (Transport block over multiple slot) PDSCH/PUSCH across SBFD and non SBFD slot. In such situation, when single DCI schedules TBoMS PDSCH/PUSCH and TBoMS PDSCH/PUSCH spread across SBFD and non SBFD slot(s). In one method, the UE is not expected to receive a configuration where, single DCI schedules TBoMS PDSCH/PUSCH and TBoMS PDSCH/PUSCH spread across SBFD and non SBFD slot(s). In another method, UE can drop the TBoMS PDSCH/PUSCH if it receives such a configuration. In another method, when single DCI schedules TBoMS PDSCH/PUSCH and slots scheduled for TBoMS PDSCH/PUSCH are falling across the SBFD and non-SBFD symbol then there can be dynamically updating of the number of slots used for the TBoMS PDSCH/PUSCH, so that TBoMS PDSCH/PUSCH can be either in SBFD slot or non-SBFD slot. In another method, when single DCI schedules TBoMS PDSCH/PUSCH and slots scheduled for TBoMS PDSCH/PUSCH are falling across the SBFD and non-SBFD symbol then gNB can configured to the UE to switch to single slot PDSCH using DCI/MAC-CE signaling explicitly. In another method, when single DCI schedules TBoMS PDSCH/PUSCH and slots scheduled for TBoMS PDSCH/PUSCH are falling across the SBFD and non-SBFD symbol then there can be implicit understanding between gNB and UE. Therefore, there can be by default configuration in which UE can switch to single slot PDSCH when slots scheduled for TBoMS PDSCH/PUSCH are falling across the SBFD and non-SBFD symbol.

In one scenario, PUCCH and PDCCH may exist in SBFD and non-SBFD symbols. In one method, the UE is not expected to receive a configuration where a single occasion PDCCH/PUCCH is mapped across SBFD and non-SBFD symbols. In another method, it drops the PDCCH/PUCCH if it receives such a configuration. In NR, PUCCH FH is allowed within a slot and across slots. In case of intra-slot hopping, the RB ID for the second hop is configured by the gNB. In case of inter-slot FH, one RB ID for even slot and one RB ID for odd slot is provided by the gNB. The rules for FH in SBFD and non-SBFD slots can be similar to handling FH for PUSCH. In one method, intra-slot FH is disabled by default in SBFD slots by the UE. In another method, if the start RB for the PUCCH falls outside the UL subband, the PUCCH is dropped. In another method, if the RB ID for the second hop falls outside the UL subband, the UE disables FH in that slot. In another method, it can also transmit only the first hop and discard the second hop. In another method, the UE calculates the RB ID for the second hop in an SBFD slot based on some defined rule in the specification or indicated by the gNB using RRC or MAC-CE or DCI signaling.

In another method, the gNB provides different FH configuration for SBFD and non-SBFD slots using RRC or MAC-CE or DCI signaling. This can include different RB IDs for the second hop. In another method, the RB ID for the second hop in an SBFD slot is determined by the UE based on some pre-defined rule indicated by the gNB using RRC or MAC-CE or DCI signaling or through the specification. E.g., the UE determines the RB ID for the second hop in an SBFD slot based on the RB ID provided by the gNB for second hop in a non-SBFD slot.

In case of inter-slot FH, if the RB ID falls outside the UL subband, the PUCCH is dropped in that slot. In another method, the UE determines the RB ID in an SBFD slot based on some pre-defined rule in specification or indicated by the gNB using RRC or MAC-CE or DCI signaling such that the RB ID is within the UL subband. In another method, the gNB provides different FH configuration for SBFD and non-SBFD slots, that is, different RB IDs for SBFD and non-SBFD slots.

In one scenario, DMRS and PDSCH/PUSCH may exist in SBFD and non-SBFD symbols. In NR, if the DMRS and the associated PDSCH/PUSCH are in different types of symbols, the quality of demodulation will get degraded due to incorrect channel estimation/interference co-variance estimation. In one method, the UE discards the PDSCH/PUSCH if the DMRS is on one type of symbol whereas the PDSCH/PUSCH is on a different type of symbol. In another method, the UE is not expected to receive such a configuration. In another method, the UE assumes that the DMRS and the PDSCH/PUSCH are on the same symbol types even if the configuration does not indicate that. In this case, the UE performs its usual demodulation but the gNB takes care that the symbols for DMRS and PDSCH/PUSCH are of same type.

In one scenario, interference estimation may need to be performed in an SBFD symbol. Within an SBFD symbol with non-overlapping, partial overlapping or fully overlapping subbands, the interference across the frequency domain of the symbol will vary. E.g., in case of non-overlapping scenario, the DL received by UE will experience interference from the UEs performing UL in the adjacent subband. This interference will be more in the DL resources that are towards the immediate adjacent to the UL subband and reduce further away from the UL subband. In case of partial overlapping scenario, the interference will be from the same UL subband. Hence, for DL CSI reporting, the UE should report for every resource block (RB) or a groups of RBs instead of sending a wideband report to capture the different interference across RBs. Similarly, for UL CSI, gNB should provide CSI feedback for every resource block (RB) or a groups of RBs.

In NR, the UE can be configured to report for each group of RBs (also known as subband) where the minimum subband granularity is 4 RBs. The subband granularity is decided based on the bandwidth part (BWP) size of the UE and the signaling using RRC. Further, the subbands to be reported for can also be selected based on a bitstring provided by the gNB in RRC. This allows contiguous and non-contiguous subband reporting. However, in NR UL CSI feedback, the gNB only sends a wideband CSI to the UE.

In one method, the subband size for reporting in DL/UL is provided to the UE by the gNB dynamically using DCI. E.g., RRC/MAC provides a set of subband sizes and the gNB indicates one of them using DCI (dedicated to one UE or group common). In another method, the gNB provides UL CSI feedback per subband/group of RBs/RB to the UE. A framework similar to DL subband CSI reporting is adopted for UL. In another method, the UE skips the CSI reports for DL in any subband that overlaps with UL resources where DL is not performed. Similarly, the gNB skips the CSI reports for UL in any subband that overlaps with DL resources where UL is not performed.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

1. A method of implementing Sub Band Full Duplexing (SBFD) in a cellular network, the method comprising:
receiving, by an at least one first node, a reference signal (RS) configuration and an SBFD configuration, wherein the RS configuration comprises at least one RS resource
identifying, by the at least one first node, that the at least one RS resource spans over at least one first resource and at least one second resource; wherein the at least one first resource is an SBFD resource and the at least one second resource is a non-SBFD resource, and
performing, by the at least one first node, one of
discarding the RS configuration,
discarding the at least one RS resource,
one of transmitting and receiving the at least one RS considering the at least one first resource and the at least one second resource to be one of SBFD resource and a non-SBFD resource based on at least one rule, and
one of transmitting and receiving the at least one RS in one of at least one first resource and at least one second resource.

2. The method as claimed in claim 1, wherein the at least one RS resource is indicated using at least one RS identity (ID).

3. The method as claimed in claim 1, wherein the rule is one of predefined in the specification and indicated by at least one second node.

4. The method as claimed in claim 3, wherein the rule is indicated using at least one of radio resource control (RRC) or medium access control-control element (MAC-CE) or downlink control information (DCI).

5. The method as claimed in claim 1, wherein the at least one first resource and the at least one second resource are consecutive in time domain.

6. The method as claimed in claim 1, wherein the at least one RS resource spans over the at least one first resource and the at least one second resource when one of
the at least one RS is repeated, and
the at least one RS is periodic.

7. The method as claimed in claim 1, wherein receiving the at least one RS further comprises:
measuring, by the at least one first node, at least one parameter using the at least one RS; and
reporting, by the at least one first node, the at least one parameter.

8. The method as claimed in claim 7, wherein measuring the at least one parameter is one of
based on the recently received at least one RS, and
based on the average of the measurements obtained using the at least one RS.

9. The method as claimed in claim 1, further comprising:
receiving by the at least one first node, a Quasi Co-location (QCL) information, wherein the QCL information comprises at least one of a control channel and a data channel QCLed with the at least one RS,
performing, by the at least one first node, one of
discarding the QCL information,
applying QCL information of the at least one RS in the at least one first resource for at least one of receiving and decoding at least one of the control channel and the data channel, and
applying QCL information of the at least one RS in the at least one second resource for at least one of receiving and decoding at least one of the control channel and the data channel.

10. The method as claimed in claim 9, wherein applying QCL information of the at least one RS in the at least one first resource is performed when at least one of the control channel and the data channel is scheduled in an SBFD resource.

11. The method as claimed in claim 9, wherein applying QCL information of the at least one RS in the at least one second resource is performed is when at least one of the control channel and the data channel is scheduled in a non-SBFD resource.

12. A method of implementing a Sub Band Full Duplexing (SBFD) in a cellular network, the method comprising:
receiving, by at least one first node, at least one reference signal (RS) configuration and a SBFD configuration, wherein the at least one RS configuration comprises at least one of at least one first RS resource and at least one second RS resource;
identifying, by at least one first node, one of
the at least one first RS resource is in an SBFD resource and at least one second resource is a non-SBFD resource, and
the at least one first RS resource is a non-SBFD resource and at least one second resource is a SBFD resource, and
performing, by the at least one first node, one of
discarding the RS configuration,
discarding the at least one first RS and at least one second RS, and
one of transmitting and receiving the at least one first RS and the at least one second RS on the resources overlapping in frequency domain of the at least one first RS and at least one second RS based on a rule.

13. The method as claimed in claim 12, wherein at least one first RS resource is for channel measurement and at least one second RS resource is for interference measurement.

14. The method as claimed in claim 12, wherein the rule is one of predefined in the specification and signaled by at least one second node.

15. The method as claimed in claim 14, wherein the rule is signaled using at least one of radio resource control (RRC) message, medium access control-control element (MAC-CE) and downlink control information (DCI).

16. The method as claimed in claim 12, wherein the resources overlapping in frequency domain are one of
the resources where one of transmission and reception is permissible and
the resources configured in at least one RS configuration.

17. The method as claimed in claim 12, further comprising determining, by the at least one first node, at least one parameter using the at least one first RS and at least one second RS.

18. The method as claimed in claim 17, wherein the at least one parameter is identified from the RS configuration.

19. A method of implementing a Sub Band Full Duplexing (SBFD) in a cellular network, the method comprising:
receiving, by at least one first node, a reference signal (RS) configuration and a SBFD configuration, wherein the RS configuration comprises a plurality of RS resources;
identifying, by the at least one first node, at least one first RS resource from the plurality of RS resources in a SBFD resource and at least one second RS resource from the plurality of RS resources in a non-SBFD resource; and
sending, by the at least one first node, a report based on at least one of the at least one first RS resource and the at least one second RS resource.

20. The method as claimed in claim 19, wherein receiving by the at least one first node further comprises receiving an indication, wherein the indication comprises report for at least one of SBFD resource and non-SBFD resource.

21. The method as claimed in claim 19, further comprising indicating, by the at least one first node, the report is for at least one of the SBFD resource and the non-SBFD resource.

22. The method as claimed in claim 19, wherein receiving, by the at least one first node, further comprises:
receiving at least one of
at least one first RS in SBFD resource and
at least one second RS in non-SBFD resource; and
measuring, by the at least one first node, at least one of
at least one first parameter using the at least one first RS and
at least one second parameter using the at least one second RS.

23. The method as claimed in claim 19, wherein the RS configuration comprises at least one parameter to report based on the plurality of resources.

24. A method of implementing a Sub Band Full Duplexing (SBFD) in a cellular network, the method comprising:
receiving, by at least one first node, configuration for at least one channel and a configuration for SBFD,
identifying, by the at least one first node, the at least one channel spans over at least one first resource and at least one second resource; wherein the at least one first resource is a SBFD resource and the at least one second resource is a non-SBFD resource; and
performing, by the at least one first node, one of
discarding the at least one channel,
one of transmission and reception of the at least one channel using at least one first parameter in the at least one first resource and at least one second parameter in the at least one second resource, and
one of transmission and reception of the at least one channel using at least one third parameter in the at least one first resource and in the at least one second resource.

25. The method as claimed in claim 24, wherein the at least one channel is one of a data channel and a control channel.

26. The method as claimed in claim 24, wherein discarding is when at least one of
frequency hopping is enabled and
resources for transmission of UL data falls outside the resource configured for UL by the configuration for SBFD.

27. The method as claimed in claim 24, wherein one of at least one first parameter and at least one third parameter is at least one of FH parameter, TCI state, TDRA, and FDRA.

28. The method as claimed in claim 24, wherein one of at least one first parameter and at least one third parameter is given by the configuration for at least one channel.

29. The method as claimed in claim 28, wherein one of at least one first parameter and at least one third parameter is obtained by disabling the FH given by the configuration for at least one channel.

30. The method as claimed in claim 24, wherein the at least one first parameter is derived from the at least one second parameter based on a rule.

31. The method as claimed in claim 30, wherein the rule is predefined in the specification and received using one of Radio Resource Control (RRC), Medium Access Control-Control Element (MAC-CE), and Downlink Control Information (DCI).

32. The method as claimed in claim 24, wherein the at least one second parameter is given by the configuration for the at least one channel.

33. The method as claimed in claim 24, wherein the configuration for at least one channel is received using one of Radio Resource Control (RRC), Medium Access Control-Control Element (MAC-CE), and Downlink Control Information (DCI).

34. The method as claimed in claim 24, wherein repetition is enabled for at least one channel or at least one channel is periodic.

35. The method as claimed in claim 24, wherein discarding at least one channel is in one of the at least one first resource and the at least one second resource based on a rule.

36. The method as claimed in claim 35, wherein the rule is one of predefined in the specification and indicated to the at least one first node.

37. The method as claimed in claim 36, wherein the indication is using one of Radio Resource Control (RRC), Medium Access Control-Control Element (MAC-CE), and Downlink Control Information (DCI) signaling.

38. The method as claimed in claim 24, wherein the third parameter is one of
configuration of the at least one channel,
configuration of at least one channel overlapping with SBFD resource, and
configuration of at least one data channel overlapping with non-SBFD resource.

39. The method as claimed in claim 24, wherein when the at least one data channel is TBoMS, discarding comprises determining at least one slot for one of transmission and reception of the at least one data channel based on one of a default configuration and indication, wherein the at least one slot is in one of the at least one first resource and the at least one second resource.

40. The method as claimed in claim 24, wherein discarding is when determining one of the at least one data channel in the at least one first resource and the associated DMRS in the at least one second resource and the at least one data channel in the at least one second resource and the associated DMRS in the at least one first resource.

41. The method as claimed in claim 24, wherein the at least one third parameter is one of corresponding to the at least one first resource when DMRS associated with the at least one data channel is in the at least one first resource and corresponding to the at least one second resource when DMRS associated with the at least one data channel is in the at least one second resource.

42. A method of implementing a Sub Band Full Duplexing (SBFD) operation in a cellular network, the method comprising:
receiving, by at least one first node, configuration for at least one control channel and a configuration for SBFD,
identifying, by the at least one first node, the at least one control channel spans over at least one first resource and at least one second resource; wherein the at least one first resource is a SBFD resource and the at least one second resource is a non-SBFD resource; and
determining, by the at least one first node, a FH pattern and performing one of transmission and reception based on the FH pattern.

43. The method as claimed in claim 42, wherein determining further comprises one of
discarding the at least one control channel when the starting frequency resource of the FH pattern is outside the resources configured for UL by the configuration for SBFD,
transmitting only in the first hop and discarding the second hop, and
calculating the RB ID for the second hop such that the resources for at least one control channel are restricted within the resources configured for UL by the configuration for SBFD.

44. The method as claimed in claim 43, wherein transmitting only in the first hop and discarding the second hop is when one of
the RB ID for the second hop falls outside the resources configured for UL, and
at least one resource for the second hop falls outside the resources configured for UL.

45. The method as claimed in claim 43, wherein the calculating is based on one of a pre-defined rule in the specification and indication received by using at least one of RRC or MAC-CE or DCI.

46. A method of implementing a Sub Band Full Duplexing (SBFD) operation in a cellular network, the method comprising:
receiving, by at least one first node, a configuration for at least one feedback and a configuration for SBFD, wherein the feedback corresponds to a plurality of resources;
dividing, by the at least one first node, the plurality of resources into a plurality of subbands; and
performing one of
receiving the at least one feedback on each subband and
measuring at least one parameter on each subband and reporting the at least one parameter as feedback.

47. The method as claimed in claim 46, wherein the dividing is based on the configuration for SBFD.

48. The method as claimed in claim 46, wherein the at least one parameter is at least one of CSI and CLI.
